(19) United States
(12) Patent Application Publication
(10) Pub. No.: US 2007/0140069 A1
(43) Pub. Date: Jun. 21, 2007

(54) Method and apparatus for reproducing data from an optical storage device

(75) Inventors: Koen J.G. Holtman, Eindhoven (NL); Wilhelmus J. van Gestel, Heeze (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/578,717

(22) PCT Filed: Nov. 10, 2004
(86) PCT No.: PCT/IB04/52376

§ 371 Date: May 10, 2006

Related U.S. Application Data
(60) Provisional application No. 60/519,170, filed on Nov. 12, 2003.

(51) Int. Cl. H04B 1/20

(52) U.S. Cl. 369/1

(57) ABSTRACT

Techniques for improved for improved seamless AB loop play, such as may be implemented in an optical disk reproducing device (100) are provided. In particular, the invention addresses the need for improved seamless AB loop play in an optical disk reproducing apparatus (100) with particular concern for two cases: (1) where the data points A and B are close together and (2) where fragmentation (non-sequential and/or non-contiguous data block storage) exists on the storage medium (101) from which the AB loop play data is to be read.

The present invention relates generally to an optical disk reproducing apparatus for reproducing digital audio/video data from an optical disk, and more particularly, to techniques for ensuring seamless AB loop play in an optical disk reproducing apparatus.

For reproduction of digital audio/video data from an optical disk, a reproducing apparatus, in general, has a “return” function for returning a current position of play. Where the same data range is to be played twice or more, a “return” operation needs to be performed each time. In this case, the final position of return can vary from user to user, since the user refers to a value of a counter, etc. A drawback of this user variability is that a desired data range is not always played each time. In order to solve this problem, an “AB repeat” function is used. According to this function, a data range to be played is designated once and reproduced repeatedly and identically in each subsequent iteration. In particular, in accordance with the AB loop play mode, two locations, a starting designation A, and a terminating designation B, are set in the digital audio/video stream (e.g., by time or byte index), and the playback apparatus displays the digital audio/video information between, and inclusive of, points A and B in and endless loop. In other words, the sequence of bytes between and inclusive of points A and B are played from start to finish in an endlessly repeated sequence, i.e., A . . . B, A . . . B, A . . . B, and so on. A desirable property of an “AB repeat” function is that the transition from point B back to point A is shown to an end user or viewer as a ‘seamless cut’ in the audio/video.

As regards the AB repeat function provided in the conventional player, there are several notable drawbacks. One problem is the practical realization of the so-called ‘seamless cut’ from point B back to point A when points A and B are close together. In particular, when points A and B are close together or in the situation where fragmentation exists on the disc (the data blocks are not stored linearly on the disc), the time that the disc spends on ‘seek’ operations is high compared to the time that data is effectively being read. Thus, the average data rate into the FIFO buffer between the disc drive and the presentation mechanism drops below the average rate at which the presentation mechanism wants to extract data. The result is a non-seamless presentation.

A further drawback is that a non-seamless presentation may also occur at points other than the jump-back point from point B to point A.

It is apparent from the foregoing that further improvements are needed in order to overcome these and other problems of the prior art.

Generally, techniques are provided for improved seamless AB loop play, such as may be implemented in an optical disk reproducing device. In particular, the invention addresses the need for improved seamless AB loop play in an optical disk reproducing apparatus with particular concern for two cases: (1) where the data points A and B are close together and (2) where fragmentation (non-sequential and/or non-contiguous data block storage) exists on the storage medium from which the AB loop play data is to be read.

The present invention addresses at least both these cases by providing a novel memory management policy in which certain data blocks are retained in the memory for re-use by the presentation mechanism in each AB loop play cycle. By retaining certain data blocks in each AB loop play cycle sufficient time is made available in each cycle to retrieve the non-retained data blocks from the disc and thereby insure seamless AB loop play.

Advantageously, by retaining only certain of the data blocks in the memory in each executed iteration of the AB loop play mode, the number of disc access operations required to supply non-retained data blocks during each cycle of the AB loop play mode of operation is reduced thus preventing buffer under-runs. This is achieved without having to store all of the data blocks between points A and B in the memory.

The foregoing features of the present invention will become more readily apparent and may be understood by referring to the following detailed description of an illustrative embodiment of the present invention, taken in conjunction with the accompanying drawings, where

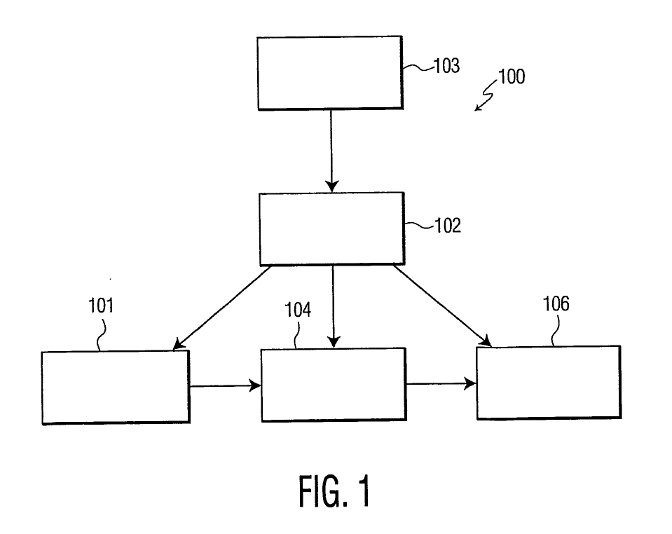

FIG. 1 shows a schematic block diagram of an optical disk reproducing device 100 for providing seamless AB loop play mode according to one embodiment of the present invention;

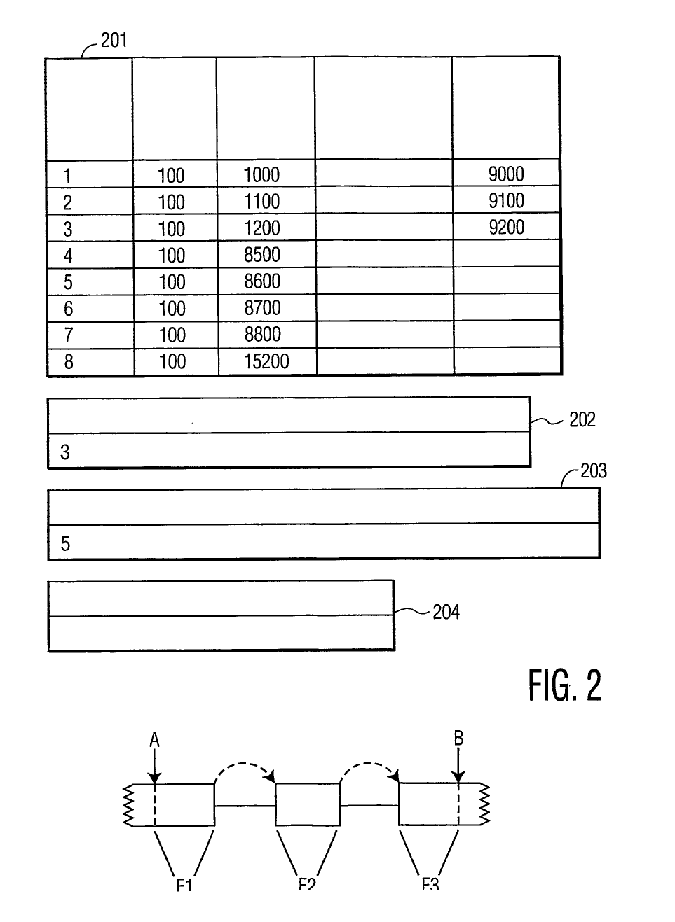

FIG. 2 is a snapshot illustration of exemplary memory data structures maintained by the controller, according to one embodiment of the present invention; and

FIG. 3 illustrates a sequence of N data blocks stored on a storage medium in three discrete fragments, i.e., (F1, F2, F3), corresponding to a (logically uninterrupted) sequence of media data between points A and B.

FIG. 1 illustrates a schematic block diagram of an optical disk reproducing device 100 for providing seamless AB loop play mode, according to one embodiment of the present invention. In particular, this embodiment of reproducing device 100 includes a controller 102, memory 104 and presentation mechanism 106.

In the preferred embodiment, the data stored on the disc drive 101, corresponding to the starting location A and the terminating location B, is divided into N discrete data blocks. For the playback of an MPEG-2 video stream, the N data blocks are generally not equal in size. Each of the N data blocks may represent a certain portion of the MPEG-2 stream, e.g. an MPEG frame. The disc drive 101 is configured to read data blocks from the disc and copy them into the memory 104, under control of the controller 102. Memory 104 provides a capability for retaining certain of the N data blocks, which comprise the AB sequence requested by a viewer for re-use in subsequent iterations of the AB loop play mode. The controller 102 implements a memory management policy, in which it keeps tracks of which data blocks are currently being stored in the memory 104, and has the option of deleting blocks from memory 104. The presentation mechanism 106 is configured to read data blocks from the memory 104. It is noted that the read operations performed by the presentation mechanism 106 are non-destructive operations. That is, the data blocks remain in memory 104 after being read by the presentation mechanism 106, unless the controller takes further actions.

The operation of the optical disk reproducing device 100, according to one embodiment, is now described. After the controller 102 receives an AB loop play command 103, it controls the operations of the device 100 by first initializing the presentation mechanism 106 to perform AB loop play back. Specifically, the controller 102 supplies the presentation mechanism 106 with starting and ending AB loop play back parameters A, B. The parameters define a range sequence of N data blocks stored on the disc drive 101. The N data blocks are displayed to a user in multiple presentation cycles in accordance with the well-known principles of AB loop play. In addition to providing the presentation mechanism 106 with the A, B parameters, the controller 102 may also supply additional information to the presentation mechanism 106. The additional information may be comprised of instructions that allow the video playback device 100 to transition seamlessly from a current mode of operation into the AB loop play mode of operation.

At a next step, the presentation mechanism 106 will perform a number of block reads from the memory 104 for display on a display device. It should be appreciated, that the controller 102 is capable of inspecting the state of the presentation mechanism 106 to determine which block is currently being displayed.

The controller 102 is also configured to instruct the disc drive 101 to read data blocks from the disc drive 101, needed by the presentation mechanism 106, which are not currently stored in the memory 104. These instructions take the form of commands to read certain data blocks from the disc drive 101 and write them into the memory 104. When the memory 104 is full (i.e., no more data blocks can be added) or nearly full, the controller 102 does not issue further commands to the disc drive 101, until more space is available again in the memory 104.

In accordance with a memory management scheme used by the controller 102, certain data blocks are removed from the memory 104 after they have been read by the presentation mechanism 106, and other data blocks are retained in the memory 104 after they have been read by the presentation mechanism 106. The retained blocks are read again from the memory 104 by the presentation mechanism 106 in subsequent AB loop presentation cycles. Retaining certain data blocks in the memory 104 provides advantages in each presentation cycle in that the retained blocks do not have to be retrieved from the disc drive 101 which can be time consuming and contribute to a non-seamless presentation.

In one embodiment, the blocks to be retained are identified such that a calculated time to retrieve the non-retained data blocks in each iteration cycle is below a threshold time for preventing a memory buffer underflow.

The specific operations of the controller 102 according to various embodiments of the invention are described below.

### Controller Embodiments

FIG. 2 is a snapshot illustration of exemplary memory data structures maintained by the controller, according to one embodiment. The snapshot illustration includes exemplary data values corresponding to a non-specified point in time during the first presentation cycle of the AB loop cycle play mode. As shown in FIG. 2, the memory data structures include table 201, counter 202, counter 203, and table 204. Counter 202 reflects the state of the presentation mechanism 106. That is, counter 202 identifies the next block to be fetched by the presentation mechanism 106. It is noted that counter 202 may be integrated within, or otherwise coupled to, the presentation mechanism 106, so that no explicit control algorithm is needed to advance it. Counter 202 starts with an initialized value of 1. Counter 203 stores a value corresponding to the next block to be read, or currently being read, by the disc drive. Table 204 keeps track of the free memory; specific methods to do this are well known and therefore, detailed descriptions thereof are not provided here.

Referring now to table 201, for each data block in the AB loop back play range (N=1, 2, . . . , 5, . . . 8), several values are maintained in the table (i.e., “Block Length”, “Position on Disc”, “Retain after fetch” and “Location in memory”.

The second column of table 201, “Block Length”, describes the number of data bytes in each block. In the instant example, the data blocks are of equal length (100), however, the data blocks may be of different lengths depending on the data organization.

The third column of table 201, “Position on disc”, describes the starting position of each block on the disc. In the instant example, it is noted that the N data blocks are stored in a non-contiguous manner on the disc. That is, gaps exist between certain of the data blocks.

The fourth column of table 201, “Retain after fetched by presentation mechanism”, identifies whether the block is to be retained or discarded subsequent to being read by the presentation mechanism. A block will receive a “Y” designation when it is decided to retain the block in the memory 104 after it has been fetched by the presentation mechanism 106. Conversely, the block receives an “N” designation when it decided not to retain the block in the memory 104 after it has been fetched by the presentation mechanism 106.

The fifth column of table 201, “Location in memory” refers to either a numerical identifier of the blocks location as stored in the memory 104 or a NULL indication when the block is not currently present in the memory 104.

In one controller embodiment, the second through fourth columns of table 201 are initialized just after the AB loop play command is received by the controller 102. The length and position information (columns 2 and 3) are obtained from meta-data structures that have been recorded on the disc. The meta-data structures may take the form of point information tables (CPI) which contain data about the block structure of the media data on disc, and file allocation tables (FAT) which map data offsets to absolute locations on disc. FAT and CPI data structures are well known and therefore, detailed descriptions thereof are not provided here.

In another controller embodiment, the fourth column may be fully initialized just after columns 2 through 3 have been initialized, using the data from columns 2 through 3, with the fourth column never changing thereafter.

In another controller embodiment, certain cases may arise in which it is advantageous to change the “Retain” decisions of column 4 from “Y” to “N” or from “N” to “Y”. Some examples of this are as follows.

Changes to the initial table values may occur due to hard to read data which is only discernable at the point in time that the data is being read, i.e., during a ‘live’ measurement. It is well know that, due to fingerprints, dust, or scratches on the disc, some blocks may require a few re-try actions by the disc drive 101 before they can be successfully read. The controller 102 could measure whether certain blocks have a higher than average read time due to disc retry actions, as the blocks are being read from the disc drive 101. For these blocks, the fourth column ‘Retain’ decision is changed from a “N” to a “Y” designation. That is, for hard to read data it becomes advantageous to retain those blocks in the memory 104. When such additional blocks are retained, some data blocks might have their “Retain” decision changed from ‘Y’ back to ‘N’, to balance the memory budget. In one embodiment, changing the “Retain” decision from ‘Y’ back to ‘N’ may be implemented by re-running the second algorithm, to be described below, with a higher value for F.

In another controller embodiment, a ‘defect management’ meta-data structure may be included on the disc that contains information about hard-to-read blocks. This information could be used instead of, or in addition to, the ‘live’ measurements described above. Defect management data structures are well known and therefore, detailed descriptions thereof are not provided here.

In another controller embodiment, the fifth column of the table, i.e., “Location in memory” is initialized to contain all NULL values, to represent an empty memory at the start.

In another controller embodiment, the controller 102 first analyzes all data that remains in the memory 104 as a remnant of a previous command received by the controller 102. If the controller 102 finds any blocks in the AB range of the current AB loop play command, it will initialize the fifth column appropriately to identify these blocks.

In a preferred controller embodiment, the controller 102 implements two main control loops, which execute in parallel. A first control loop for managing the disc drive 101 and a second main control loop for determining which blocks are not to be retained in the memory. The two control loops are described with particular reference to FIGS. 2 and 3.

The first main control loop for managing the disc drive 101 operates as follows:

1^{st} Control Loop for Managing the Disc Drive

1. Initialization step: set counter 203=1.
2. Wait until there is sufficient free memory to store at least 1 new block in the memory 104.
3. Using table 201, check whether the block presently identified by counter 203 is in the memory 104. If it is already in the memory, advance counter 203 by 1, and then continue at the start of step 3. It is noted that counter 203 is a wraparound counter such that when the end of the AB loop data range is reached, the next counter value stored is 1.
4. Issue a command to the disc drive 101 to fetch the block indicated by counter 203.
5. Wait until the disc drive has completed placing the block in memory, responsive to the command at step 4.
6. Update table 201 to reflect the memory location of the block placed in memory.
7. Return to step 2.

A variation of the 1^{st} control loop can use ‘pipelining’ techniques to create a queue of multiple commands for the disc drive; this variation can be advantageous if the disc drive is of a type that gives a higher overall performance (in throughput and/or latency) if such a command queue is used. Pipelining techniques are well known and therefore, detailed descriptions thereof are not provided here.

2^{nd} Control Loop for Managing the Deletion of Blocks from the Memory 104

1. Wait until the counter 202 advances.
2. Consider the identity of the block pointed to by counter 202 just prior to the counter advancing at step 1, e.g., block “B”.
3. If in table 201, the ‘retain’ flag of block B is set to ‘Y’, then return to step 1.
4. Delete block B from the memory, update tables 201 and 204 accordingly.
5. Return to step 1.

In alternative embodiments, the 2^{nd} control loop could be implemented as being integral to the presentation mechanism 106 instead of the controller 102.

Many alternative block retention/deletion algorithms may be considered for deciding which blocks are to be retained in the memory during each presentation cycle of AB loop play mode. For example, the block retention/deletion decisions could be made by the controller alone, based on information accessible by the controller. Alternatively, the block retention/deletion decisions are not made exclusively by the controller, instead, external parameters (sent together with the AB loop play command) may be used to assist in the block retention/deletion process. For example, the AB loop play command could include one or more parameters defining the list of blocks that should be retained.

One example of a practical system that utilizes external parameters is a gaming system, where the game involves AB loop playback of video fragments, possibly with computer-generated graphics blended in. In this case, the central controlling component of the game program could supply both the AB loop play command, and a list of blocks to retain to the controller. This embodiment allows the author of the game to make the best possible use of the (limited) memory available in the system, without requiring the presence of an advanced selection algorithm inside the controller.

A game author can also increase the effectiveness of the (limited) memory available in the system by the combined measures of restricting the possible AB loop play commands to a certain specific set, and simultaneously creating a layout of the data on the disc that is tailored to optimize the disc access speeds for this specific set.

The purpose of the block retention/deletion decision process is to optimize the playback quality experienced by the user, according to some quality criteria. Possible criteria include (1) Eliminating or minimizing the chance that a memory buffer underflow can occur, where a memory buffer underflow is defined herein as a situation where the presentation mechanism needs to read a certain block from memory (in order to continue its AB loop play presentation) and the needed block is not present in memory to be read, and (2) The first criterium with the distinction that, if buffer underflows must occur, a mechanism is in place that ensures that the buffer underflows occur predominantly at a boundary transition, i.e., from point B back to point A in the presentation cycle.

Block retention/deletion decisions that satisfy the above criteria, whether made by the controller, an outside body, or a combination of the two, can be based on the following considerations. (1) The speed at which data is read from the memory by the presentation mechanism (2) The performance profile of the disc drive (i.e., the speed of read and seek operations), (3) The allocation of the blocks on disc, with particular reference to ‘holes’ in the allocation profile of the disc. A ‘hole’ is generally defined as a non-contiguous storage sequence of two consecutive data blocks of the AB sequence, (for example, see blocks 4 and 5 of table 201, where block 4 is stored at position 1300 and block 5 is stored at position 8500) and (4) Knowledge about blocks having a higher than average read time.

To illustrate how block selection decisions may be made in dependence upon the afore-mentioned considerations, a number of block selection algorithms are described below. In each of the algorithms to be described, it is assumed that the block selection decisions are to be made for an exemplary sequence of N blocks between a starting point A and a terminating point B on a storage medium, as is commonly defined in AB loop play. It is further assumed that the N data blocks are stored in non-contiguous fashion on the storage medium, as illustrated in FIG. 3.

FIG. 3 illustrates a sequence of N data blocks, identified by points A and B in a (logically uninterrupted) sequence of media data, stored on a storage medium in three discrete fragments, i.e., (F1, F2, F3). In the block selection algorithms to be described it is assumed that a memory for storing the data blocks is of a size M, where M<N.

1^{st} Block Selection Algorithm

In the first block selection algorithm, a parameter X is used to select the first X blocks, starting from point A in the logical media data sequence AB. Parameter X is such that X<M, for example X=M/2.

The first algorithm works well if certain boundary conditions on the allocation of the data on disc are met. Specifically, in some existing multimedia playback systems, the scattering of data on disc (i.e., data fragmentation) is constrained in such a way that, for playback of any particular logically contiguous stream of data it is guaranteed that there will be no FIFO buffer underflows, assuming a FIFO buffer of size F is used with the FIFO buffer starting full. In this case, the 1^{st} algorithm described above prevents buffer underflows provided that the following conditions are satisfied:
(a)X+F<=M Eq. [1]
(b)T_{—}X>T_Seek+T_Fill Eq. [2]
Condition (b) states that the time T_X needed by the presentation mechanism to consume X blocks of data is greater than T_Seek+T_Fill, where T_Seek is the worst-case time needed by the disc drive to jump from one position to another position on the disc, and T_Fill is the worst case time needed to fill a FIFO of size F with a logically contiguous sequence of blocks. It is noted that, under these conditions, by selecting the first X blocks in accordance with the 1^{st} algorithm, the desired goal of limiting buffer underflows is met. Alternative embodiments may select a different set of X blocks with the choice being driven by additional considerations, such as, for example, considering the allocation of the blocks on the disc.

The parameter X can be either a fixed parameter, computed when implementing the controller, or a secondary algorithm might be used to compute an appropriate X for each AB loop command instance, based on some additional considerations.

2^{ND} Block Selection Algorithm

The 2^{nd} block selection algorithm takes into account the allocation of the blocks on disc. More particularly, the location of ‘holes’ in the allocation of the blocks on the disc. The algorithm can be stated as follows:

At a first act, initialize a variable F to be equal to the number of positions in the memory that will not be used to retain blocks. An appropriate value may be chosen for F by a system designer.

At a second act, analyze the allocation of blocks between points A and B Inclusive of the end-points, to identify ‘holes’ in the allocation. This analysis yields a set of ‘seek points’ S, with each member of S identifying one such hole. In the illustrative example of FIG. 3, the set S includes a first hole between F1 and F2 and a second hole between F2 and F3.

At a third act, add to the set S the seek point from point B back to point A.

At a fourth act, set a variable NS to the number of members in the set S.

At a fifth act, for each member S_i of S, calculate a variable R_i, which is the number of blocks to retain around the seek point S_i. The number of blocks to be retained may be calculated in one way as:
R_{—}i=int((X−F)/NS) Eq. [3]
where the “int” function rounds down an integer number.

At a sixth act, for each member S_i of S, identify the R_i blocks just before the hole as the blocks that should be retained.

3^{rd} Block Selection Algorithm

The 3^{rd} block selection algorithm is a variant of the 2^{nd} block selection algorithm. In the present algorithm, the fifth act is refined to take calculated access times into account. Specifically, the fifth act may be replaced by the following fifth act comprised of 4 sub-acts:

At act 5.1, for each member S_i of S, calculate a variable Seek_i corresponding to the time required by a disc seek operation from the block just before S_i to the block just after S_i.

At act 5.2, for each member S_i of S, calculate a variable Blocks_i, corresponding to the number of blocks consumed by the presentation mechanism in the time Seek_i.

At act 5.3, compute a variable Total_blocks as the sum of all values Blocks_i.

At act 5.4, for each member S_i of S, calculate
R_{—}i=int(Blocks_{—}i*min(1,((X−F)/Total_blocks))) Eq. [4]
where the “min” function returns the smallest of its two arguments.
4^{th} Block Selection Algorithm

This algorithm first executes the 3^{rd} block selection algorithm, and then checks if Total_blocks>X−F. When this is true, then the selection that was just made by the algorithm is discarded, and the 3^{rd} block selection algorithm is executed again. However, in this second iteration, act 2 recited above is omitted. This has the effect ensuring that if underflows must occur, they occur predominantly when there is a boundary transition from B back to A in the presentation cycle.

A particular concern with each of the algorithms described above is that unless some of the N blocks are already present in the memory before the start of the first presentation cycle of the AB loop play operation, the first cycle is particularly vulnerable to the risk of buffer under-runs. To compensate for this vulnerability, it is contemplated that the presentation of blocks is delayed until a sufficient number of blocks have been read. The blocks to be read can be either blocks from the start of the AB range, or blocks that have been selected to be retained, or some combination of the above.

An alternative solution might be to start the presentation cycle immediately and take the possibility of buffer under-runs for granted.

The choice between each of the proposed solutions depends on a tradeoff between start-up speed and quality.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A method for providing seamless AB loop play in a reproducing apparatus (100), the method comprising the acts of:
receiving a command (103) to enter an AB loop play mode, said command (103) including at least a starting point parameter A and a terminating point parameter B;
identifying a set of N data blocks stored on a storage medium(101), responsive to said command (103);
retrieving said N data blocks from said storage medium (101);
storing said N data blocks in a memory;
reading said N data blocks from said memory (104) in a first presentation cycle of said AB loop play mode;
presenting said N data blocks to a user in said first presentation cycle of said AB loop play mode;
deleting a first subset of data blocks P from among said stored N data blocks from said memory (104) subsequent to reading said first subset P of data blocks from said memory (104); and
retaining a second subset of data blocks M from among said stored N data blocks in said memory (104) subsequent to reading said second subset of data blocks from said memory (104) for use in one or more subsequent presentation cycles of said A-B loop play.

2. The method of claim 1, further comprising the acts of:
retrieving said deleted first subset of data blocks P from said storage medium (101) for use in said one or more subsequent presentation cycles of said A-B loop play; and
presenting said retrieved first subset of data blocks P and said retained second subset of data blocks M to said user in said one or more subsequent presentation cycles of said AB loop play.

3. The method of claim 1, wherein said request further comprises an identifier of at least one data block to be retained from among said second subset of data blocks M to be retained in said one or more subsequent presentation cycles of said AB loop play.

4. The method of claim 1, further comprising the act of identifying at least one data block to be retained from among said second subset of data blocks M to be retained, wherein said identification is made in dependence upon knowledge of disc retrieval times of at least one data block from among said N data blocks.

5. The method of claim 4, wherein said knowledge of said disc retrieval times is a knowledge of higher than average disc retrieval times of said at least one data block from among said N data blocks.

6. The method of claim 1, further comprising the act of identifying at least one data block from among said second subset of data blocks M to be retained in dependence upon an allocation profile of said N data blocks on said storage medium (101).

7. The method of claim 6, wherein said dependence upon said allocation profile includes a dependence upon discontinuities in said allocation profile.

8. The method of claim 1, wherein the act of retaining said second subset of data blocks M in said memory (104), further comprises the act of retaining the first X blocks from among said N data blocks retrieved from said memory (104) in said one or more subsequent presentation cycles of said AB loop play.

9. The method of claim 2, wherein said first subset of data blocks P to be retrieved and second subset of data blocks M to be retained are determined such that a calculated time to retrieve said first subset of data blocks P in said one or more subsequent presentation cycles is below a threshold time.

10. The method of claim 9, wherein said threshold time corresponds to a time below which a memory (104) buffer underflow cannot occur.

11. The method of claim 9, wherein said calculated time is computed in dependence upon pre-supplied data included in said request identifying at least one of said data blocks M to be retained in said one or more subsequent presentation cycles of said AB loop play.

12. The method of claim 9, wherein said calculated time is computed in dependence upon knowledge of certain of said data blocks M from among said N data blocks having a higher than average retrieval time.

13. The method of claim 9, wherein said calculated time is computed in dependence upon an allocation profile of said N data blocks on said storage medium (101).

14. The method of claim 13, wherein said dependence upon said allocation profile includes a dependence upon discontinuities in said allocation profile.

15. The method of claim 2, wherein said first subset of data blocks P and said second subset of data blocks M are determined such that a calculated time to retrieve said first subset P in said one or more subsequent presentation cycles minimizes the number of occurrences of a memory buffer underflow

16. The method of claim 15, wherein said calculated time is computed in dependence upon pre-supplied data included in said request identifying at least one of said data blocks M.

17. The method of claim 15, wherein said calculated time is computed in dependence upon knowledge of certain data blocks from among said N data blocks having an associated higher than average retrieval time.

18. The method of claim 15, wherein said calculated time is computed in dependence upon an allocation profile of said N data blocks on said storage medium (101).

19. The method of claim 18, wherein said dependence upon said allocation profile includes a dependence upon discontinuities in said allocation profile.

20. The method of claim 1, wherein said first subset of data blocks P and said second subset of data blocks M are determined such that a calculated time to retrieve said first subset P in said one or more subsequent presentation cycles is sufficient to prevent a memory buffer underflow except at a boundary transition from a terminating point defined by a terminating point parameter B to a starting point defined by a starting point parameter A in said one or more presentation cycles.

21. The method of claim 20, wherein said calculated time is computed in dependence upon pre-supplied data included in said request identifying at least one of said data blocks M.

22. The method of claim 20 wherein said calculated time is computed in dependence upon knowledge of certain data blocks from among said N data blocks having an associated higher than average retrieval time.

23. The method of claim 20, wherein said calculated time is computed in dependence upon an allocation profile of said N data blocks on said storage medium (101).

24. The method of claim 23, wherein said dependence upon said allocation profile includes a dependence upon discontinuities in said allocation profile.

25. A method for providing seamless AB loop play in a reproducing apparatus, the method comprising the acts of:
retaining, in a memory (104), a first subset of data blocks M from a sequence of N data blocks in one or more presentation cycles of said AB loop play mode; and
retrieving, from a storage medium (101), a second subset of data blocks P from said sequence of N data blocks in said one or more presentation cycles of said AB loop play mode,
wherein said first subset of data blocks M and said second subset of data blocks P collectively comprise N data blocks to be displayed in said one or more presentation cycles of said AB loop play.

26. The method of claim 25 wherein said calculated time is computed in dependence upon pre-supplied data included in said request identifying at least one of said data blocks M.

27. The method of claim 25, wherein said at least one data block from among said first subset of data blocks M is identified in dependence upon knowledge of certain of said M data blocks having a higher than average retrieval time.

28. The method of claim 25, wherein at least one data block from among said first subset of data blocks P is identified in dependence upon an allocation profile of said N data blocks on said storage medium (101).

29. The method of claim 28, wherein said dependence upon said allocation profile includes dependence upon discontinuities in said allocation profile.

30. The method of claim 25, wherein said first subset of data blocks M and said second subset of data blocks P are determined such that a calculated time to retrieve said first subset P of data blocks in said one or more presentation cycles minimizes the number of occurrences of a memory buffer underflow.

31. The method of claim 25, wherein said first subset of data blocks P and said second subset of data blocks M are determined such that a calculated time to retrieve said first subset P of data blocks in said one or more subsequent presentation cycles is sufficient to prevent a memory buffer underflow except at a boundary transition from a terminating point defined by a terminating point parameter B to a starting point defined by a starting point parameter A in said one or more presentation cycles.

32. A playback apparatus for providing seamless AB loop play in a reproducing system, the apparatus comprising:
a memory (104) configured to store a subset of N data blocks;
a presentation mechanism (106) configured to read said stored data blocks from said memory (104) for display to a user in a plurality of successive AB loop presentation cycles;
a controller (102) configured to retrieve said N data blocks from a storage medium (101) to be stored in said memory (104), receive and process requests to enter said AB loop play, initialize the presentation mechanism (106) to perform said AB loop play;
the controller (102) being further configured to remove a first subset of data blocks P from the memory (104) subsequent to being read by the presentation mechanism (106) and retain a second subset of data blocks M in the memory (104) subsequent to being read by the presentation mechanism (106).

33. The playback apparatus of claim 32, wherein said controller (102) identifies said first subset of data blocks P and said second subset of data blocks M such that a calculated time to retrieve said first subset of data blocks P from said storage medium (101) in said plurality of successive AB loop presentation cycles is below a threshold time.

34. The playback apparatus of claim 33, wherein said threshold time corresponds to a time below which a memory buffer underflow cannot occur.

35. The playback apparatus of claim 32, wherein said controller (102) identifies at least one data block from among said second subset of data blocks M in accordance with pre-supplied data included in said request.

36. The playback apparatus of claim 32, wherein said controller (102) is further configured to identify at least one data block from among said second subset of data blocks M in dependence upon knowledge of certain of said M data blocks having an associated higher than average retrieval time.

37. The playback apparatus of claim 32, wherein at least one data block from among said first subset P of data blocks is identified in dependence upon an allocation profile of said N data blocks on said storage medium (101).

38. The playback apparatus of claim 33, wherein said dependence upon said allocation profile includes a dependence upon discontinuities in said allocation profile.

39. The playback apparatus of claim 32, wherein said first subset of data blocks M and said second subset of data blocks P are determined such that a calculated time to retrieve said first subset P of data blocks in said one or more presentation cycles minimizes the number of occurrences of a memory buffer underflow.

40. The playback apparatus of claim 32, wherein said first subset of data blocks P and said second subset of data blocks M are determined such that a calculated time to retrieve said first subset P of data blocks in said one or more subsequent presentation cycles is sufficient to prevent a memory buffer underflow except at a boundary transition from a terminating point defined by a terminating point parameter B to a starting point defined by a starting point parameter A in said one or more presentation cycles.
